(19) United States
(12) Patent Application Publication
(10) Pub. No.: US 2004/0169672 A1
(43) Pub. Date: Sep. 2, 2004

(54) Display apparatus, display method, network system and terminal device

(75) Inventor: Masao Misumi, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/626,838

(22) Filed: Jul. 25, 2003

(30) Foreign Application Priority Data
Jul. 26, 2002 (JP) 2002-218430

(51) Int. Cl. G06F 17/00

(52) U.S. Cl. 345/700

(57) ABSTRACT

A display apparatus comprises a part for displaying an image of a Web page, and a script which performs processing of changing the displayed image to a link destination.

### CROSS-REFERENCE TO RELATED APPLICATIONS

This application is based upon and claims the benefit of priority from the prior Japanese Patent Application No. 2002-218430, filed Jul. 26, 2002, the entire contents of which are incorporated herein by reference.

### BACKGROUND OF THE INVENTION

1. Field of the Invention

The present invention relates to a Web page display apparatus, a Web page image display method, a network system, and a terminal device which are applied when a Web page image is acquired and displayed via a network such as the Internet or Intranet.

2. Description of the Related Art

Conventionally, in a system for acquiring and displaying a Web page image via a network such as the Internet or Intranet, when the Web page displayed on a screen is changed, there is provided a change button or portion capable of recognizing change operation by a user in each web page. A link destination of the page to be next displayed is set (defined) in this change button so that the display change is performed by displaying the link destination of the pushed change button.

However, only one link destination can be set in the change button. Since the change button in the next page and the change button in the previous page are different in the link destination even when the images on the screens are identical, different Web page data is required to create. Therefore, in the above Web page configuration, when the amount of data is increased along with increase in the number of pages so that the number of pages becomes larger, there is a problem that the amount of data is remarkably increased. Further, since it is required that the page data of the link destination is acquired via the network from a server each time when the page is changed, the amount of data transferred on the network is increased and much processing time is required for page display processing. As a result, there have been problems in cost efficiency and functionality.

As described above, conventionally, in the Web page display processing, when the amount of data is increased along with increase in the number of pages, there has been the problem that the amount of data is remarkably increased. In addition, since it is required that the page data of the link destination is acquired via the network from the server, the amount of data transferred on the network is increased and much processing time is required for the page display processing, leading to problems in cost efficiency and functionality.

### BRIEF SUMMARY OF THE INVENTION

A display apparatus according to a first embodiment of the present invention is characterized by comprising: means for displaying an image of a Web page; and a script which performs processing of changing the displayed image to a link destination.

A display method according to a second embodiment of the present invention is characterized by comprising: preparing a script which performs processing of changing a displayed Web page image to a link destination; and performing image change to a link destination page by script processing.

A network system, in which a client side device acquires data of a Web page from a server side device to display an image of the Web page, according to a third embodiment of the present invention is characterized by comprising a script which performs image display change to a link destination of a displayed Web page in the client side device, in which the client side device acquires and displays image data of a link destination from the server side device through processing of the script.

A terminal device for acquiring data of a Web page via a network and displaying an image of the Web page according to a fourth embodiment of the present invention is characterized by comprising: means for acquiring data of an operation screen which designates a link destination of the displayed image; means for displaying an operation screen on the basis of the data of the operation screen acquired by the first means; and a script which, when the operation screen displayed in the means for displaying an operation screen is operated, acquires image data of a link destination according to the operation and performs processing of changing the displayed image to the link destination.

A terminal device according to a fifth embodiment of the present invention is characterized by comprising: means for acquiring data of a linked image in units of one image via a network; means for displaying an image on the basis of the data acquired by the means for acquiring data of the linked image; means for acquiring data of an operation screen which designates a link destination of the image displayed by the means for displaying the image; means for displaying an operation screen on the basis of the data of the operation screen acquired by the means for acquiring data of the operation screen; means for determining a link destination of the image according to the operation of the operation screen displayed by the means for displaying the operation screen; and means for changing the image displayed by the means by reflecting a determination result of the means for determining the link destination of the image on the means for acquiring data of the linked image.

A terminal device according to a sixth embodiment of the present invention is characterized by comprising: means for acquiring data of a linked image in units of several images via a network; means for displaying the image in units of one image on the basis of the data acquired by the means for acquiring data of the linked image; means for acquiring data of an operation screen which designates a link destination of the image displayed by the means for displaying the image; means for displaying an operation screen on the basis of the data of the operation screen acquired by the means for acquiring data of the operation screen; means for determining a link destination of the image according to the operation of the operation screen displayed by the means for displaying the operation screen; means for determining whether or not the link destination determined by the means for determining the link destination of the image is data of the image already acquired by the first means for acquiring data of the linked image; and seventh means for, when it is determined that the link destination is data of the image already acquired by the sixth means for determining, reflecting the determination result on the second means for displaying the image and when it is determined that the link destination is not data of the image already acquired by the sixth means for determining, reflecting the determination result on the first means for acquiring data of the linked image so as to change the image displayed by the means for displaying the image.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a block diagram showing a system configuration according to first and second embodiments of the present invention;

FIG. 2 is a block diagram showing a configuration of a terminal device according to the above embodiments;

FIG. 3 is a diagram showing a configuration example of an image display area and an operation screen of a Web page according to the above embodiments;

FIG. 4 is a diagram showing a configuration example of image data of the Web page and data of the operation screen according to the above embodiments;

FIG. 5 is a flow chart showing a procedure of acquisition data in an initial screen according to the above embodiments;

FIG. 6 is a flow chart showing a procedure of displaying the initial screen according to the embodiments;

FIG. 7 is a flow chart showing a procedure of changing image display to a link destination according to the first embodiment of the invention;

FIG. 8 is a flow chart showing a procedure of changing image display to a link destination according to the first embodiment of the invention;

FIG. 9 is a flow chart showing a procedure of changing image display to a link destination according to the first embodiment of the invention;

FIG. 10 is a flow chart showing a procedure of changing image display to a link destination according to the first embodiment of the invention;

FIG. 11 is a flow chart showing a procedure of changing image display to a link destination according to the second embodiment of the invention; and

FIG. 12 is a flow chart showing a procedure of changing image display to a link destination according to the second embodiment of the invention.

### DETAILED DESCRIPTION OF THE INVENTION

Hereinafter, embodiments according to the present invention will be described with reference to the drawings.

FIG. 1 is a block diagram showing a configuration of a system to which the embodiments according to the present invention are applied. The system comprises a server 10, a terminal device 20 serving as a client, and a network 30 such as the Internet or Intranet. The server 10 stores data of a Web page to be provided to the terminal device 20 therein. The terminal device 20 stores a script for performing image display change to a link destination described later therein. The terminal device 20 performs a script processing and acquires image data of the link destination from the server 10 via the network 30 to display the Web page image of the link destination.

The “Web page” is defined as each page, which is described in HTML, disclosed on a web site and a screen displayed by using a www browser is called as a “web page” in the specification.

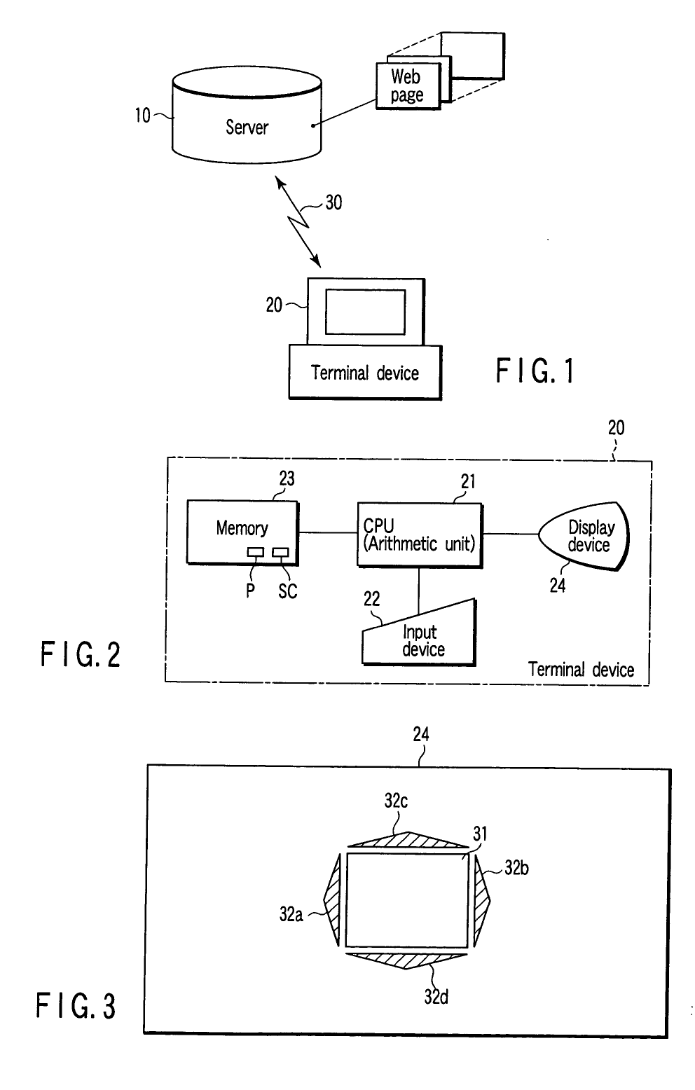

As shown in FIG. 2, the terminal device 20 comprises an arithmetic unit 21, an input device 22, a memory 23, and a display device 24.

The arithmetic unit 21 includes a CPU and performs various processings as shown in FIGS. 5 to 12 including the script processing for changing image display to a link destination described later.

The input device 22 is an input device such as a keyboard, a pointing device, or the like, where, when a user performs a screen change (link destination designating) operation, the operation is detected to be notified to the arithmetic unit 21.

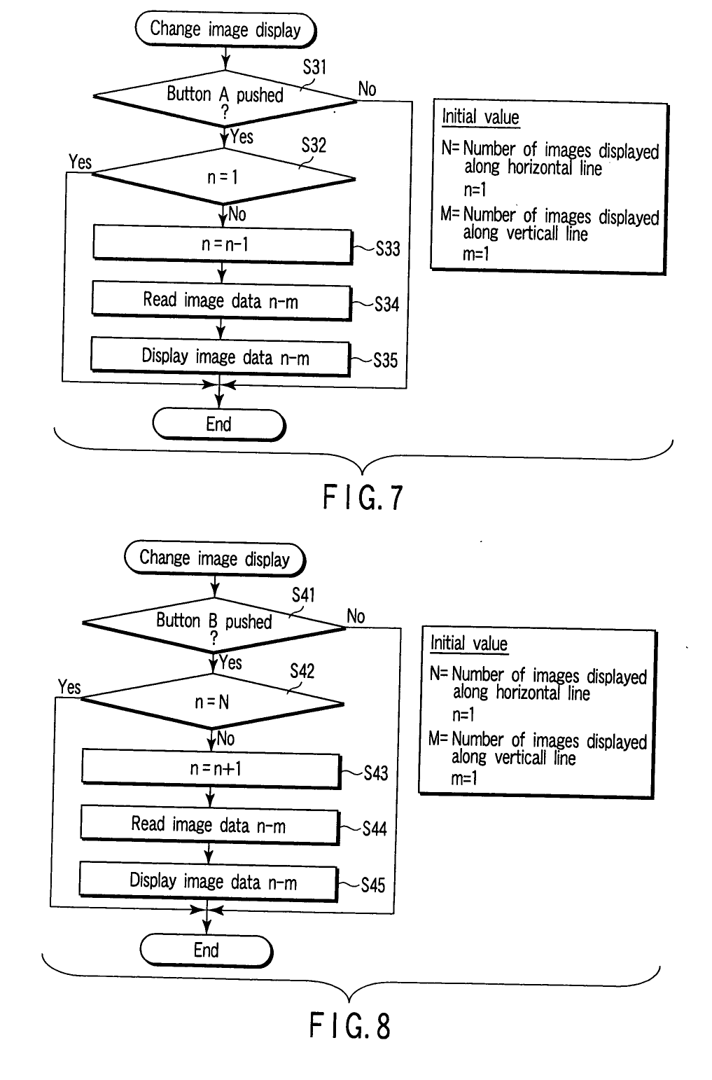

The memory 23 is configured with either RAM or RAM and ROM, and stores a program (P) for performing processing of acquiring operation screen data and image data configuring an initial screen of the Web page (refer to FIG. 5) and processing of displaying the initial screen according to the acquired data (refer to FIG. 6), and the script (SC) for performing change of image display to a link destination (refer to FIGS. 7 to 12).

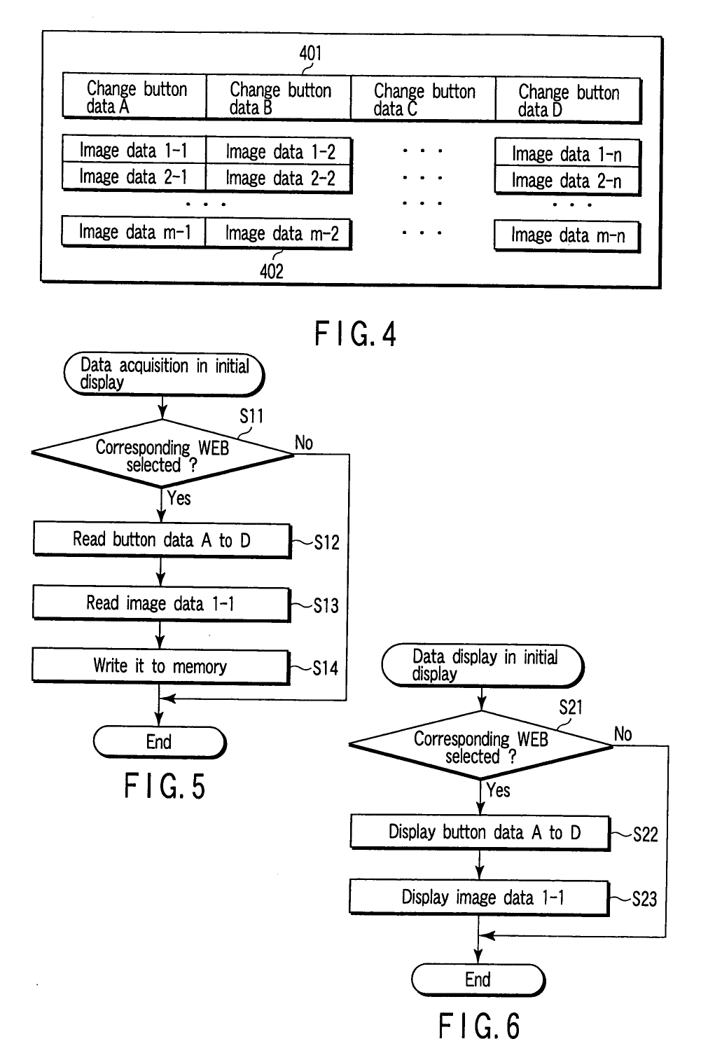

Further, the memory 23 stores the Web page data acquired from the server 10 by the processing of acquiring the operation screen data and the image data, the processing of acquiring the link destination image data, and the like therein. This Web page data is configured of the image data and the operation screen data for designating the link destination (refer to FIG. 4) and is individually accessed for each item of data. In other words, the memory 23 has an image data storage area and a storage area. The image data storage area stores therein the initial image data acquired in the data acquisition processing shown in FIG. 5 and the link destination image data acquired in the script processing (refer to FIGS. 7 to 12) described later. The storage area stores therein the operation screen data which is acquired in the data acquisition processing shown in FIG. 5 and is directed for designating the link destination. The memory 23 enables the data in the respective storage areas to be independently accessed, respectively (refer to FIG. 4).

The display device 24 displays each item of the initial and link destination image data of the Web page in units of one image under control of the arithmetic unit 21 and displays the operation screen for designating the link destination of the displayed image.

FIG. 3 shows a configuration example of the image display area and the operation screen of the Web page displayed on the display device 24. In the screen configuration shown in FIG. 3, there are provided image change buttons 32a, 32b, 32c, and 32d for designating a link destination in the corresponding direction in the respective sides (left side, right side, upper side, and lower side) in the surrounding of the image display area 31 in which the Web page image is displayed. A link destination in an arbitrary direction can be designated for a virtual screen configured of an image of N (horizontal)×M (vertical) such as a map screen through the operation of the image change buttons 32a, 32b, 32c, and 32d.

FIG. 4 shows a data configuration example of the image data and the operation screen of the above Web page. Data 401 of the image change buttons 32a, 32b, 32c, and 32d shown in FIG. 3 and image data 402 to be changed are stored in the storage device in the server 10, respectively, and are accessed for data to be stored in the memory 23 of the terminal device 20.

The change button data 401 is configured of change button data A, B, C, and D defining the display and function of the image change buttons 32a, 32b, 32c, and 32d shown in FIG. 3. The change button data 401 is also read-accessed from the storage device of the server 10 in units of the above change button data 401 in response to a Web page display request from the terminal device 20, and is transferred to the terminal device 20 via the network 30.

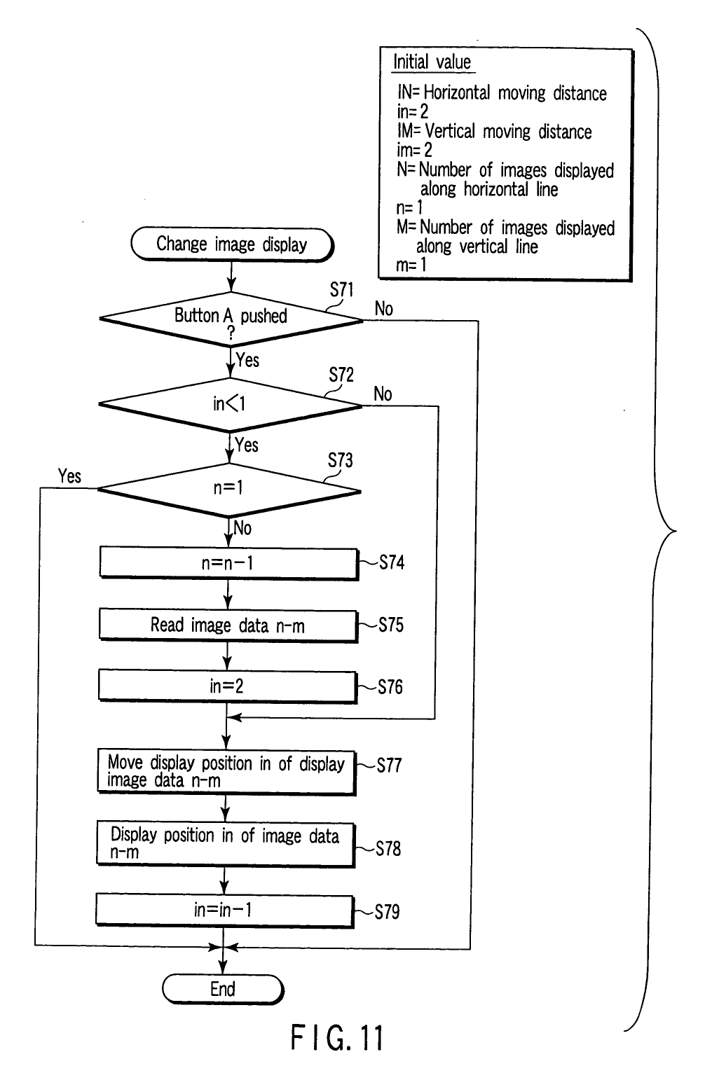

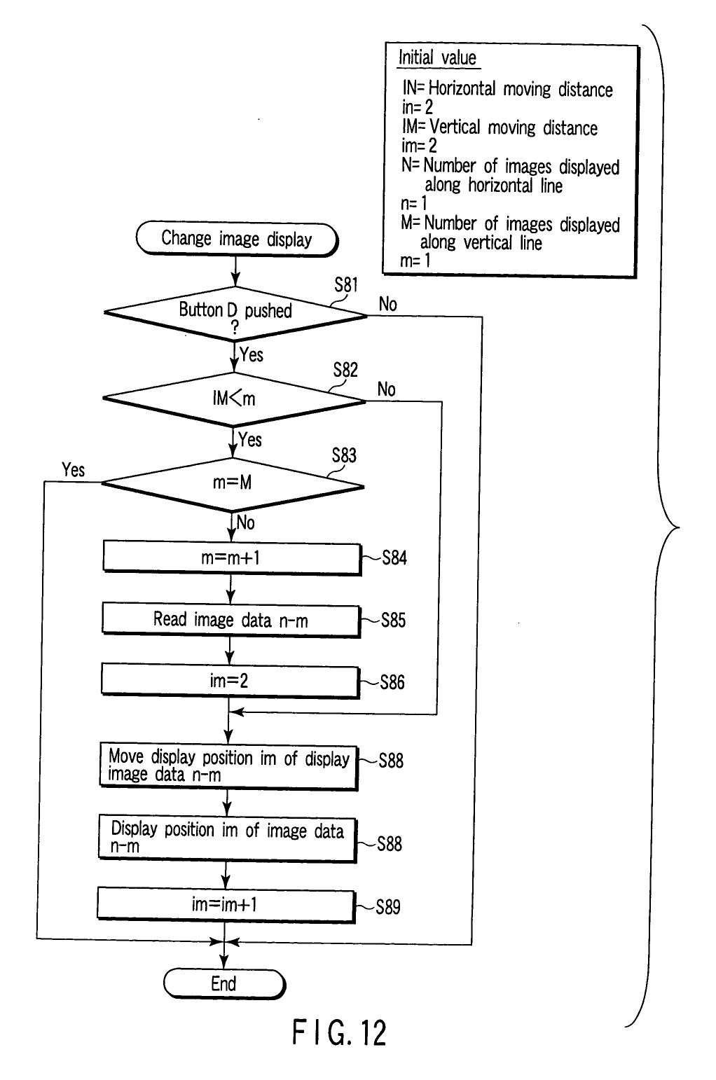

In addition, the image data 402 stored in the storage device of the server 10 is configured of image data of N×M (1-1, 1-2, . . . , 1-n, 2-1, 2-2, . . . , 2-n, . . . , m-1, m-2, . . . , m-n), where the horizontal direction is denoted by N and the vertical direction is denoted by M, as one example of the Web page handled in the embodiments. The image data 402 is accessed in units of one image according to the first embodiment (refer to FIGS. 7 to 10) and in units of several images according to the second embodiment (refer to FIGS. 11 and 12), and is transferred to the terminal device 20 via the network 30.

When a Web page is selected, the arithmetic unit 21 performs the processing of acquiring data in the initial screen shown in FIG. 5, and subsequently performs the processing of displaying the initial screen shown in FIG. 6 through, for example, a click operation on the display screen. Further, when any one of the image change buttons 32a, 32b, 32c, and 32d in FIG. 3, which are displayed on the display device 24 by the processing of displaying the initial screen shown in FIG. 6, is operated, the arithmetic unit 21 performs the processing of changing image display to the link destination shown in FIGS. 7 to 10 in the first embodiment and performs the processing of changing image display to the link destination shown in FIGS. 11 and 12 in the second embodiment according to the script (SC) prepared in the memory 23 in advance. In the flow charts shown in FIGS. 7 to 12, the change buttons 32a, 32b, 32c, and 32d shown in FIG. 3 are denoted as buttons A, B, C, and D, respectively. Further, the number of linked images (number of displayed images) is denoted by N (horizontal)×M (vertical), an image count value in the horizontal direction is denoted by n, and an image count value in the vertical direction is denoted by m.

Here, a Web page display processing operation according to the embodiments of the present invention will be described with reference to each drawing.

First, the Web page display processing operation according to the first embodiment of the invention will be described with reference to FIGS. 1 to 10.

The change button data 401 and the image data 402 are stored in the storage device of the server 10 as the Web page data as shown in FIG. 4.

When the server 10 receives the Web page display request sent from the terminal device 20, the change button data 401 and the image data 402 (1-1) configuring the initial screen are transferred to the terminal device 20 via the network 30.

In the terminal device 20, the arithmetic unit 21 performs the processing of acquiring the operation screen data and the image data configuring the initial screen shown in FIG. 5 and the processing of displaying the initial screen shown in FIG. 6 according to the program (P) stored in the memory 23.

In the processing of acquiring the operation screen data and the image data configuring the initial screen, the change button data 401 and the image data 402 (1-1) configuring the initial screen are received from the server 10 via the network 30 (steps S11 to S13 in FIG. 5). Then, the received change button data 401 and image data 402 (1-1) are written in the memory 23 (step S14 in FIG. 5).

In the processing of displaying the initial screen, the change button data 401 and the image data 402 (1-1) stored in the memory 23 are read out and displayed on the display device 24 (steps S21 to S23 in FIG. 6).

FIG. 3 shows a configuration example of the image data and the operation screen of the Web page displayed on the display device 24. In this screen configuration, there are provided the image change buttons 32a, 32b, 32c, and 32d for designating a link destination in the corresponding direction in the respective sides (left side, right side, upper side, and lower side) in the surrounding of the image display area 31 in which the Web page image is displayed.

Here, when any one of the image change buttons 32a, 32b, 32c, and 32d is operated (for example, operated by clicking), the arithmetic unit 21 performs the processing of changing image display to the link destination according to the script (SC).

When the image change button 32a (button A) is operated (step S31 in FIG. 7), a determination is made as to whether or not an image to be linked is present in the left of the image displayed in the image display area 31 (step S32 in FIG. 7).

When the image to be linked is not present in the left of the image displayed in the image display area 31 (YES in step S32 in FIG. 7), the operation of the image change button 32a (button A) is disabled.

When the image to be linked is present in the left of the image displayed in the image display area 31 (NO in step S32 in FIG. 7), the image count value (n) in the horizontal direction is decremented (step S33 in FIG. 7) and the image data of the link destination is acquired from the server 10 (step S34 in FIG. 7) so that the image displayed in the image display area 31 is changed to the image of the link destination (step S35 in FIG. 7).

Moreover, when the image change button 32b (button B) is operated (step S41 in FIG. 8), a determination is made as to whether or not an image to be linked is present in the right of the image displayed in the image display area 31 (step S42 in FIG. 8).

When the image to be linked is not present in the right of the image displayed in the image display area 31 (YES in step S42 in FIG. 8), the operation of the image change button 32b (button B) is disabled.

When the image to be linked is present in the right of the image displayed in the image display area 31 (NO in step S42 in FIG. 8), the image count value (n) in the horizontal direction is incremented (step S43 in FIG. 8) and the image data of the link destination is acquired from the server 10 (step S44 in FIG. 8) so that the image displayed in the image display area 31 is changed to the image of the link destination (step S45 in FIG. 8).

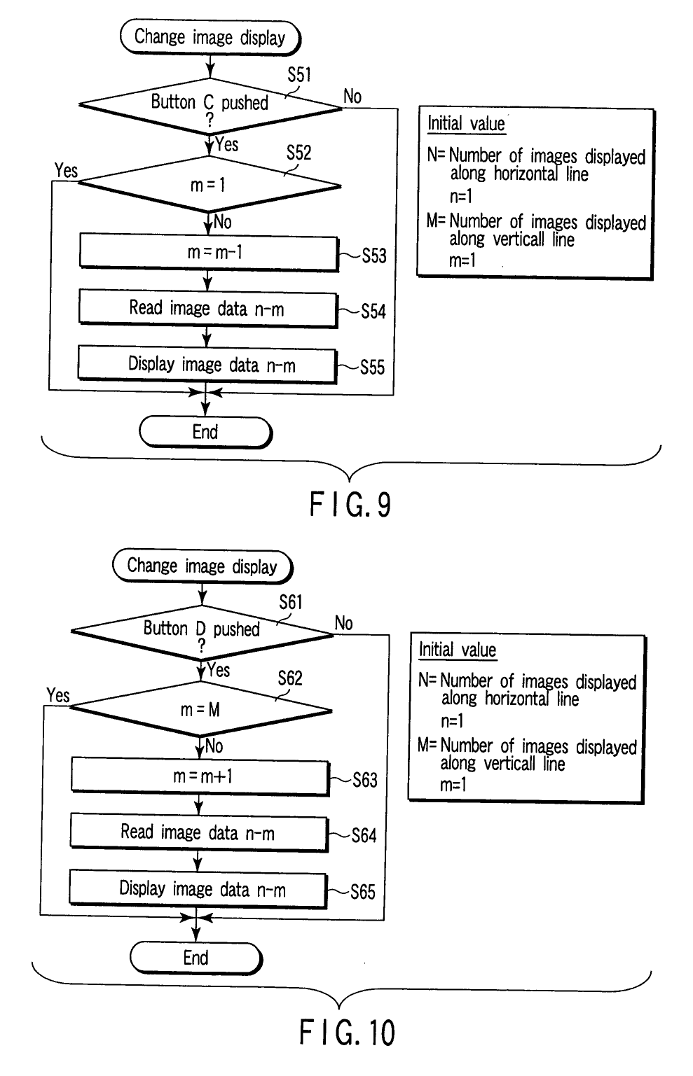

When the image change button 32c (button C) is operated (step S51 in FIG. 9), a determination is made as to whether or not an image to be linked is present above the image displayed in the image display area 31 (YES in step S52 in FIG. 9).

Here, when the image to be linked is not present above the image displayed in the image display area 31 (YES in step S52 in FIG. 9), the operation of the image change button 32c (button C) is disabled.

When the image to be linked is present above the image displayed in the image display area 31 (NO in step S52 in FIG. 9), the image count value (m) in the vertical direction is decremented (step S53 in FIG. 9) and the image data of the link destination is acquired from the server 10 (step S54 in FIG. 9) so that the image displayed in the image display area 31 is changed to the image of the link destination (step S55 in FIG. 9).

When the image change button 32d (button D) is operated (step S61 in FIG. 10), a determination is made as to whether or not an image to be linked is present below the image displayed in the image display area 31 (step S62 in FIG. 10).

Here, when the image to be linked is not present below the image displayed in the image display area 31 (YES in step S62 in FIG. 10), the operation of the image change button 32d (button D) is disabled.

When the image to be linked is present below the image displayed in the image display area 31 (NO in step S62 in FIG. 10), the image count value (m) in the vertical direction is incremented (step S63 in FIG. 10) and the image data of the link destination is acquired from the server 10 (step S64 in FIG. 10) so that the image displayed in the image display area 31 is changed to the image of the link destination (step S65 in FIG. 10).

In this manner, the image change buttons 32a, 32b, 32c, and 32d are operated so that a link destination in an arbitrary direction can be designated for the virtual screen configured of the image of N (horizontal)×M (vertical) such as a map screen.

As described above, according to the first embodiment, the script for performing processing of changing the displayed image to a link destination is provided so that the change button data and the image data are individually handled. Therefore, the data capacity of the entire Web page can be reduced so that the web page data can be efficiently transferred and the Web page display processing can be efficiently performed. Further, the image change buttons 32a, 32b, 32c, and 32d have only to read from the server 10 only one time at the time of displaying the initial screen and only the image data has to be acquired from the server 10 with respect to the succeeding change to the link destination each time when the image change buttons 32a, 32b, 32s, and 32d are operated. Thereby, the transfer efficiency of the Web page data on the network can be improved.

Next, the Web page display processing operation according to the second embodiment of the present invention will be described with reference to FIGS. 1 to 6 and FIGS. 11 and 12.

The first embodiment is the script processing where the linked image data is acquired from the server 10 via the network 30 in units of an image for one screen displayed in the image display area 31 each time when the image change buttons 32a, 32b, 32c, and 32d are operated. On the contrary, in the second embodiment, the image data for several images is acquired from the server 10 at one time, and is stored in the memory 23. Then, the image data is not requested to the server 10 when the image data of the link destination designated through the operation of the image change buttons 32a, 32b, 32c, and 32d is already acquired (stored in the memory 23), and the already acquired image data of the link destination is displayed in the image display area 31. Thereby, the number of times of accesses to the server 10 at the time of displaying the Web page is reduced so that the transfer efficiency of the Web page can be further improved. Furthermore, the image change to the link destination can be efficiently performed at high speed. In the script processing shown in FIGS. 11 and 12, there is shown a processing example where the image data for two screens in the horizontal direction (horizontal moving distance) or two displays in the vertical direction (vertical moving distance) is acquired from the server 10 at one time.

In the script processing according to the second embodiment, when the image change button 32a (button A) is operated (step S71 in FIG. 11), a determination is made as to whether or not the data of the image to be linked is present in the left of the image displayed in the image display area 31 (step S72 in FIG. 11).

Here, when the data of the image to be linked is already acquired (NO in step S72 in FIG. 11), the image data is read from the memory 23, the image displayed in the image display area 31 is changed to the image of the link destination (steps S77 and S78 in FIG. 11), and the image count value (in) of the horizontal moving distance is decremented (step S79 in FIG. 11) so that the image change processing along with the operation of the image change button 32a (button A) is terminated.

When the image data of the link destination is not included in the already acquired image data (not present in the memory 23) (YES in step S72 in FIG. 11), a determination is made as to whether or not the image to be linked is present in the left of the image displayed in the image display area 31 (step S73 in FIG. 11).

Here, when the image to be linked is not present in the left of the image displayed in the image display area 31 (YES in step S73 in FIG. 11), the image change processing along with the operation of the image change button 32a (button A) is terminated.

Further, when the image to be linked is present in the left of the image displayed in the image display area 31 (NO in step S73 in FIG. 11), the image count value (n) in the horizontal direction is decremented (step S74 in FIG. 11), the image data for two screens in the horizontal direction (or image data for one screen at the leftmost end) is acquired (step S75 in FIG. 11) so that the image count value (in) of the horizontal moving distance is set to 2 (two screens) (step S76 in FIG. 11). Thereafter, the image displayed in the image display area 31 is changed to the image of the link destination (steps S77 and S78 in FIG. 11) and the image count value (in) of the horizontal moving distance is decremented (step S79 in FIG. 11) so that the image change processing along with the operation of the image change button 32a (button A) is terminated.

When the image change button 32d (button D) is operated (step S81 in FIG. 12), a determination is made as to whether or not the data of the image to be linked is already acquired below the image displayed in the image display area 31 (step S82 in FIG. 12).

Here, when the image data of the link destination is already acquired (NO in step S82 in FIG. 12), the image data is read from the memory 23, the image displayed in the image display area 31 is changed to the image of the link destination (steps S87 and S88 in FIG. 12), and the image count value (im) of the vertical moving distance is incremented (step S89 in FIG. 12) so that the image change processing along with the operation of the image change button 32d (button D) is terminated.

Further, when the image data of the link destination is not included in the already acquired image data (not present in the memory 23) (YES in step S82 in FIG. 12), a determination is made as to whether or not the image to be linked is present below the image displayed in the image display area 31 (step S83 in FIG. 12).

Here, when the image to be linked is not present below the image displayed in the image display area 31 (YES in step S83 in FIG. 12), the image change processing along with the operation of the image change button 32d (button D) is terminated.

When the image to be linked is present below the image displayed in the image display area 31 (NO in step S83 in FIG. 12), the image count value (m) in the vertical direction is incremented (step S84 in FIG. 12), the image data for two screens in the vertical direction (or image data for one screen at the lowermost end) is acquired (step S85 in FIG. 12) and the image count value (im) of the vertical moving distance is set to 2 (two screens) (step S86 in FIG. 12). Thereafter, the image displayed in the image display area 31 is changed to the image of the link destination (steps S87 and S88 in FIG. 12) and the image count value (im) of the vertical moving distance is incremented (step S89 in FIG. 12) so that the image change processing along with the operation of the image change button 32d (button D) is terminated.

Additionally, the image change processing when the image change button 32b (button B) is operated and the image change processing when the image change button 32c (button C) is operated can be easily understood from each image change processing according to the first embodiment and shown in FIGS. 11 and 12. Therefore, the detailed description of the image change processing operation will be omitted.

Providing the script processing function according to the second embodiment makes it possible to reduce the number of times of accesses to the server 10 at the time of displaying the Web page, to improve the transfer efficiency of the Web page data, and to efficiently perform the image change to the link destination at high speed.

A Web page display apparatus according to one embodiment of the present invention is characterized by comprising display means for acquiring and displaying a Web page image, a script for changing a link destination of the image, and processing means therefor. Since a script processing function of changing a link destination of an image is newly added, only image data is read and displayed at the change of the link destination and the entire page is not reread. As a result, the data transfer from a server is not required to wait. In addition, even when the number of images configuring the Web page is increased, the entire page (common portion other than the image data) requires only one page so that the amount of data can be restricted.

The Web page display apparatus according to one embodiment of the present invention is characterized by comprising: means for displaying an image of a Web page; and a script which performs processing of changing the displayed image to a link destination. Here, the apparatus is characterized by further comprising means for designating an arbitrary link destination from a plurality of link destinations, wherein processing of changing an image to the link destination designated by the means for designating the arbitrary link destination is performed by the script when the means for designating the arbitrary link destination is operated. Further, the apparatus is characterized by further comprising mean for acquiring image data of an initial screen and display data of a change button which designates a link destination of a displayed image as initial screen data of the Web page and displaying an initial screen and a change button of the Web page on the basis of the acquired image data and the display data of the change button, in which the script processing is performed when the change button is operated so that the image display change to a link destination is performed. Furthermore, the Web page display apparatus is characterized by comprising means for acquiring the image data of the Web page in units of several pages including at least one page link destination and performing image display change to a link destination by including the image data acquired in units of several pages in an image change target to the link destination through the script processing when the change button is operated.

A Web page image display method according to one embodiment of the present invention is characterized by comprising: preparing a script which performs processing of changing a displayed image to a link destination; and performing image change to a link destination page by script processing. Here, the method is characterized by further comprising: acquiring image data of an initial screen and display data of a change button which designates a link destination of the displayed image as initial screen data of the Web page; and displaying the initial image and the change button of the Web page on the basis of the acquired image data and the display data of the change button, in which the script processing is performed when the change button is operated, so that the display change of only the image of the link destination is performed.

A network system, in which a client side device acquires data of a Web page from a server side device to display an image of the Web page, according to one embodiment of the present invention is characterized by comprising a script which performs image display change to a link destination of a displayed Web page in the client side device, in which the client side device acquires and displays image data of a link destination from the server side device through processing of the script. Here, the network system is characterized by further comprises means for individually managing image data of the Web page and data of an operation screen which designates a link destination of the image data, sending the image data in the initial screen and the data in the operation screen to the client side device of the Web page request source at the time of transferring the data in the initial screen of the Web page, and sending only image data of the link destination to the client side device of the Web page request source at the time of transferring the data of the Web page other than the initial screen. Further, the network system is characterized in that the client side device displays an initial image and a link destination designating button as an initial screen on the basis of the image data and the operation screen data acquired from the server side device, and acquires image data of a link destination according to the operation of the link destination designating button from the server through processing of the script when the link destination designating button is operated to perform image display change to the link destination.

A terminal device for acquiring data of a Web page via a network and displaying an image of the Web page according to one embodiment of the present invention is characterized by comprising: means for acquiring data of an operation screen which designates a link destination of the displayed image; means for displaying an operation screen on the basis of the data of the operation screen acquired by the first means; and a script which, when the operation screen displayed in the means for displaying an operation screen is operated, acquires image data of a link destination according to the operation and performs processing of changing the displayed image to the link destination.

A terminal device according to another embodiment of the present invention is characterized by comprising: means for acquiring data of a linked image in units of one image via a network; means for displaying an image on the basis of the data acquired by the means for acquiring data of the linked image; means for acquiring data of an operation screen which designates a link destination of the image displayed by the means for displaying the image; means for displaying an operation screen on the basis of the data of the operation screen acquired by the means for acquiring data of the operation screen; means for determining a link destination of the image according to the operation of the operation screen displayed by the means for displaying the operation screen; and means for changing the image displayed by the means by reflecting a determination result of the means for determining the link destination of the image on the means for acquiring data of the linked image.

A terminal device according to still another embodiment of the present invention is characterized by comprising: means for acquiring data of a linked image in units of several images via a network; means for displaying the image in units of one image on the basis of the data acquired by the means for acquiring data of the linked image; means for acquiring data of an operation screen which designates a link destination of the image displayed by the means for displaying the image; means for displaying an operation screen on the basis of the data of the operation screen acquired by the means for acquiring data of the operation screen; means for determining a link destination of the image according to the operation of the operation screen displayed by the means for displaying the operation screen; means for determining whether or not the link destination determined by the means for determining the link destination of the image is data of the image already acquired by the first means for acquiring data of the linked image; and seventh means for, when it is determined that the link destination is data of the image already acquired by the sixth means for determining, reflecting the.determination result on the second means for displaying the image and when it is determined that the link destination is not data of the image already acquired by the sixth means for determining, reflecting the determination result on the first means for acquiring data of the linked image so as to change the image displayed by the means for displaying the image.

As described above, according to the embodiments of the present invention, there can be provided a Web page display apparatus, a Web page image display method, a network system, and a terminal device capable of efficiently performing data transfer and processing of displaying Web page data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
means for displaying an image of a Web page; and
a script which performs processing of changing the displayed image to a link destination.

2. The display apparatus according to claim 1, further comprising means for designating an arbitrary link destination from a plurality of link destinations, wherein processing of changing an image to the link destination designated by the means for designating the arbitrary link destination is performed by the script when the means for designating the arbitrary link destination is operated.

3. The display apparatus according to claim 1, further comprising mean for acquiring image data of an initial screen and display data of a change button which designates a link destination of a displayed image as initial screen data of the Web page and displaying an initial screen and a change button of the Web page on the basis of the acquired image data and the display data of the change button,
wherein the script processing is performed when the change button is operated so that the image display change to a link destination is performed.

4. The display apparatus according to claim 3, wherein the change button has one or a plurality of buttons which designates a link destination of at least any one of forward, backward, left, and right.

5. The display apparatus according to claim 3, wherein the change button is provided around a display area of the initial and link destination images.

6. The display apparatus according to claim 3, further comprising means for acquiring the image data of the Web page by several linked images, wherein an image display change to a link destination is performed by including the plurality of items of acquired image data in the link destinations to be changed through the script processing when the change button is operated.

7. A display method comprising:
preparing a script which performs processing of changing a displayed Web page image to a link destination; and
performing image change to a link destination page by script processing.

8. The display method according to claim 7, further comprising:
acquiring image data of an initial screen and display data of a change button which designates a link destination of the displayed image as initial screen data of the Web page; and
displaying the initial image and the change button of the Web page on the basis of the acquired image data and the display data of the change button,
wherein the script processing is performed when the change button is operated, so that the display change of only the image of the link destination is performed.

9. A network system in which a client side device acquires data of a Web page from a server side device to display an image of the Web page, comprising a script which performs image display change to a link destination of a displayed Web page in the client side device,
wherein the client side device acquires and displays image data of a link destination from the server side device through processing of the script.

10. The network system according to claim 9, wherein the server side device further comprises means for managing, as data of the Web page, only image data of the Web page and sending image data according to a page designation request of a link destination to the client side device.

11. The network system according to claim 9, the server side device further comprises means for individually managing image data of the Web page and data of an operation screen which designates a link destination of the image data, sending the image data in the initial screen and the data in the operation screen to the client side device of the Web page request source at the time of transferring the data in the initial screen of the Web page, and sending only image data of the link destination to the client side device of the Web page request source at the time of transferring the data of the Web page other than the initial screen.

12. The network system according to claim 11, wherein the client side device displays an initial image and a link destination designating button as an initial screen on the basis of the image data and the operation screen data acquired from the server side device, and acquires image data of a link destination according to the operation of the link destination designating button from the server through processing of the script when the link destination designating button is operated to perform image display change to the link destination.

13. A terminal device for acquiring data of a Web page via a network and displaying an image of the Web page, comprising:
means for acquiring data of an operation screen which designates a link destination of the displayed image;
means for displaying an operation screen on the basis of the data of the operation screen acquired by the first means; and
a script which, when the operation screen displayed in the means for displaying an operation screen is operated, acquires image data of a link destination according to the operation and performs processing of changing the displayed image to the link destination.

14. A terminal device comprising:
means for acquiring data of a linked image in units of one image via a network;
means for displaying an image on the basis of the data acquired by the means for acquiring data of the linked image;
means for acquiring data of an operation screen which designates a link destination of the image displayed by the means for displaying the image;
means for displaying an operation screen on the basis of the data of the operation screen acquired by the means for acquiring data of the operation screen;
means for determining a link destination of the image according to the operation of the operation screen displayed by the means for displaying the operation screen; and
means for changing the image displayed by the means by reflecting a determination result of the means for determining the link destination of the image on the means for acquiring data of the linked image.

15. A terminal device comprising:
means for acquiring data of a linked image in units of several images via a network;
means for displaying the image in units of one image on the basis of the data acquired by the means for acquiring data of the linked image;
means for acquiring data of an operation screen which designates a link destination of the image displayed by the means for displaying the image;
means for displaying an operation screen on the basis of the data of the operation screen acquired by the means for acquiring data of the operation screen;
means for determining a link destination of the image according to the operation of the operation screen displayed by the means for displaying the operation screen;
means for determining whether or not the link destination determined by the means for determining the link destination of the image is data of the image already acquired by the means for acquiring data of the linked image; and
means for, when it is determined that the link destination is data of the image already acquired by the means for determining, reflecting the determination result on the means for displaying the image and when it is determined that the link destination is not data of the image already acquired by the means for determining, reflecting the determination result on the means for acquiring data of the linked image so as to change the image displayed by the means for displaying the image.

16. The terminal device according to claim 13, wherein the operation screen is configured of one or a plurality of buttons which designates a link destination of at least any one of forward, backward, left, and right.

17. The terminal device according to claim 13, wherein the operation screen is displayed around a display area where the initial and link destination images are displayed.
